(19) United States
(12) Patent Application Publication
(10) Pub. No.: US 2003/0002883 A1
(43) Pub. Date: Jan. 2, 2003

(54) Cartridge detachably mountable on image forming apparatus

(75) Inventors: Minoru Sato, Shizuoka (JP); Teruhiko Sasaki, Shizuoka (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/171,630

(22) Filed: Jun. 17, 2002

(30) Foreign Application Priority Data
Jun. 18, 2001 (JP) 183663/2001 (PAT.

(51) Int. Cl. G03G 15/08

(52) U.S. Cl. 399/102; 399/103

(57) ABSTRACT

A cartridge detachably mountable on an image forming apparatus, including a frame and a blade member held by the frame, wherein a double-sided adhesive tape is stuck between the frame and the blade member along the lengthwise direction of the blade member.

### BACKGROUND OF THE INVENTION

1. Field of the Invention

The invention relates to an cartridge mounted on an image forming apparatus such as a copying machine or a printer for forming an image by the use of a recording technique of the electrophotographic type, the electrostatic recording type or the like.

2. Description of Related Art

As a cartridge mounted on an image forming apparatus, there is, for example, one which comprises a photosensitive member, a charger, a developing device and a cleaner made into a unit. Besides this, there is one which is divided into a cartridge holding a photosensitive member and a cartridge holding a developing device.

As described above, the heart portion of the image forming apparatus is made into a cartridge simply interchangeable and thus, even an ordinary user can effect the maintenance of the apparatus.

In the presentday image forming apparatuses, a powdered toner is generally used as a developer for depicting an image on recording paper. Because of being powder, the toner is liable to leak and particularly, a cartridge containing the toner therein is given vibration by the user's handling and therefore the toner is liable to leak therefrom. For this reason, various contrivances have been made so that the toner may not leak.

FIG. 27 of the accompanying drawings shows a cross-sectional view of a cartridge P which will be instructive for understanding the present invention. This cartridge P carries therein, as main constituents, a photosensitive member 103, a charging roller 104 for charging the photosensitive member 103, a developing roller 105 bearing thereon a toner for developing an electrostatic latent image formed on the photosensitive member, a cleaning blade 106 abutting against the photosensitive member to thereby clean the photosensitive member, and a shutter 107 for protecting the photosensitive member. The reference numeral 108 designates a toner containing chamber, the reference numeral 109 denotes a developing chamber, the reference numeral 110 designates an opening for connecting the toner containing chamber and the developing chamber together, the reference numeral 111 denotes a seal for closing the opening 110 (this seal is stripped off when the cartridge begins to be used), the reference numeral 112 designates a layer thickness regulating blade (developing blade) for regulating the layer thickness of the toner formed on the developing roller 105, and the reference numeral 113 denotes end portion seals for preventing the leakage of the toner from the opposite ends of the developing roller.

FIG. 29 of the accompanying drawings is an exploded view and an assembly view of a frame forming the toner containing chamber and the developing chamber. As shown in FIG. 29, the toner containing chamber and the developing chamber are formed by superposing frame parts 101 and 102 made of synthetic resin one upon the other. The frame parts 101 and 102 are coupled together by a coupling method such as ultrasonic welding, whereby the leakage of the toner from the gap between the two is prevented.

Now, the developing blade 112 comprises a blade 112a made of rubber and attached to a support member 112b made of a metal by such means as adhesive securing, and the lengthwisely opposite end portions of the support member 112b of the developing blade 112 are fixed to the frame part 101 by screws 114. FIGS. 26A and 26B of the accompanying drawings show enlarged views of the attached portion of the developing blade. Between the frame part 101 and the developing blade 112, an elastic seal 115 such as foamed polyurethane is compressed and sandwiched as shown in FIG. 26A, or a portion 101a of the frame part 101 is caused to eat into the blade 112a as shown in FIG. 26B, to thereby prevent the leakage of the toner from between the developing blade 112 and the frame part 101.

FIG. 28A of the accompanying drawings is a cross-sectional view of the lengthwisely central portion of a cartridge, and this cartridge somewhat differs in shape from the cartridge shown in FIG. 27, but is substantially the same as the cartridge of FIG. 27 in the structure of the attached portion of the developing blade. The reference numeral 116 designates a toner agitating member provided in the toner containing chamber, and this toner agitating member 116 is rotated so that the tip end 116a thereof may describe a locus indicated by dot-and-dash line. Although not shown, on the left side of FIG. 28A, the photosensitive member, the cleaner, etc. are mounted as in FIG. 27.

When as shown in FIG. 28A, the user holds the cartridge in his hand H, the frame is sometimes deformed by the force thereof as shown in FIG. 28B of the accompanying drawings. When the frame is deformed, a gap is created between the developing blade 112 and the frame part 101 as shown in FIG. 28B, and in the case of the seal construction as shown in FIG. 26B, the toner leaks from this gap (this gap is largest in the central portion of the developing blade which is not fixed by a screw because the lengthwisely opposite ends of the developing blade are fixed to the frame by the screws 114). Even when the elastic seal 115 is sandwiched between the developing blade 112 and the frame part 101 as shown in FIG. 26A, a gap may be formed between the elastic seal 115 and the developing blade 112. Also, even if a gap is not formed and the leakage of the toner can be prevented, a portion of the frame part 101 may contact which the toner agitating member 116 mounted in the toner containing chamber 108 due to the deformation of the frame part 101 and may damage the tip end 116a thereof. Even when due to the deformation of the frame, the toner agitating member and the frame do not interfere with each other, the deformation of the frame is not preferable in the sealing performance of the cartridge. It would occur to mind to make the thickness of the frame great in order to prevent the deformation of the frame, but this method will result in the increased weight of the cartridge.

In the case of the cartridge handled by the user, as described above, the compatibility of the increased sealing performance between the blade member and the frame and the increased rigidity of the frame is required.

### SUMMARY OF THE INVENTION

The present invention has been made in view of the above-noted problem and an object thereof is to provide a cartridge which achieves the compatibility of the increased sealing performance between a blade member and a frame and the increased rigidity of the frame.

Another object of the present invention is to provide a cartridge which achieves the compatibility of the increased sealing performance between a blade member and a frame and the increased rigidity of the frame by a simple method.

Still another object of the present invention is to provide a cartridge comprising:

a frame; and

a blade member held by the frame;

wherein a double-sided adhesive tape is stuck between the frame and the blade member along the lengthwise direction of the blade member.

Further objects of the present invention will become apparent from the following detailed description when read with reference to the accompanying drawings.

### BRIEF DESCRIPTION OF THE DRAWINGS

FIG. 1 is a cross-sectional view schematically showing the construction of an electrophotographic image forming apparatus.

FIG. 2 is a cross-sectional view schematically showing the construction of a process cartridge.

FIG. 3 is a perspective view of the process cartridge.

FIG. 4 is a perspective view of the process cartridge.

FIG. 5 is an assembly perspective view of cleaning means and developing means.

FIG. 6 is an assembly perspective view of the cleaning means and the developing means.

FIG. 7 is an assembly perspective view of the cleaning means and the developing means.

FIG. 8A is a perspective view of a toner seal member, and FIG. 8B is an enlarged cross-sectional view of the toner seal member.

FIG. 9 is a view showing an assembly of a toner developing frame, a lid member and the toner seal member.

FIG. 10 is a view showing a combination of the toner developing frame, the lid member and the toner seal member.

FIG. 11 is an assembly perspective view of the developing means.

FIG. 12 is a cross-sectional view of the vicinity of a developing blade.

FIG. 13 is a schematic perspective view of the process cartridge as it is inserted into the image forming apparatus.

FIG. 14 is an assembly detailed view of the cleaning means.

FIG. 15 is an assembly detailed view of the cleaning means.

FIG. 16 is a cross-sectional view of an end portion member and a handle member.

FIG. 17 is a cross-sectional view of the end portion member and the handle member.

FIG. 18 is a cross-sectional view of the end portion member and the handle member.

FIG. 19 is a perspective view of a process cartridge mounting and dismounting mechanism.

FIG. 20 is an illustration of the operation of inserting the process cartridge into the process cartridge mounting and dismounting mechanism shown in FIG. 19.

FIG. 21 is an illustration of the operation of inserting the process cartridge into the process cartridge mounting and dismounting mechanism shown in FIG. 19.

FIG. 22 is an illustration of the operation of inserting the process cartridge into the process cartridge mounting and dismounting mechanism shown in FIG. 19.

FIG. 23 is an illustration of the operation of inserting the process cartridge into the process cartridge mounting and dismounting mechanism shown in FIG. 19.

FIG. 24 is an illustration of the operation of inserting the process cartridge into the process cartridge mounting and dismounting mechanism shown in FIG. 19.

FIGS. 25A and 25B are illustrations of the positional relation in the lengthwise direction between the convex portion of a back lid in an opening W and the projected portion of the process cartridge.

FIGS. 26A and 26B are cross-sectional views of the vicinity of a developing blade according to the conventional art.

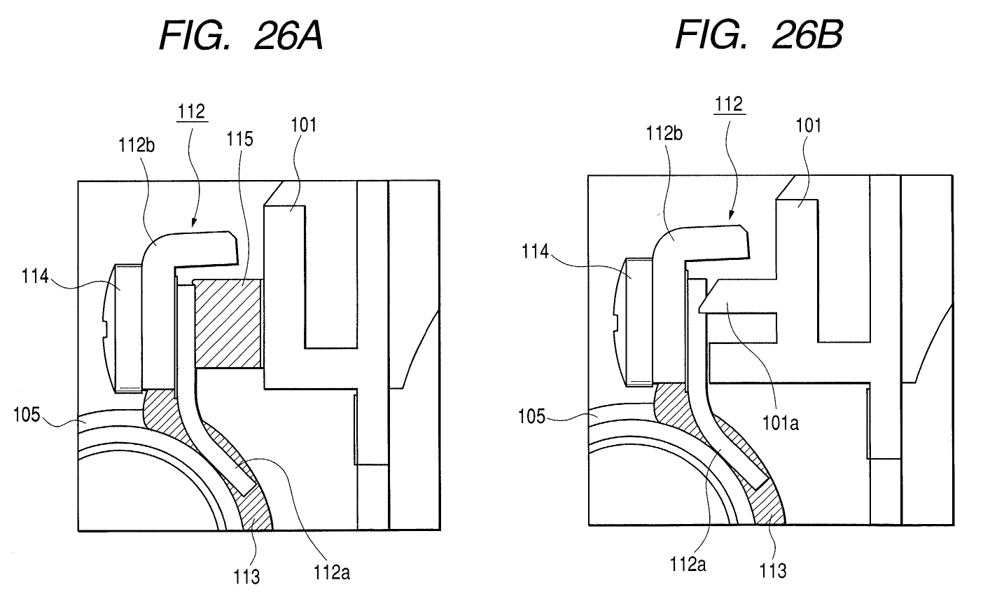

FIG. 27 is a cross-sectional view of a cartridge according to the conventional art.

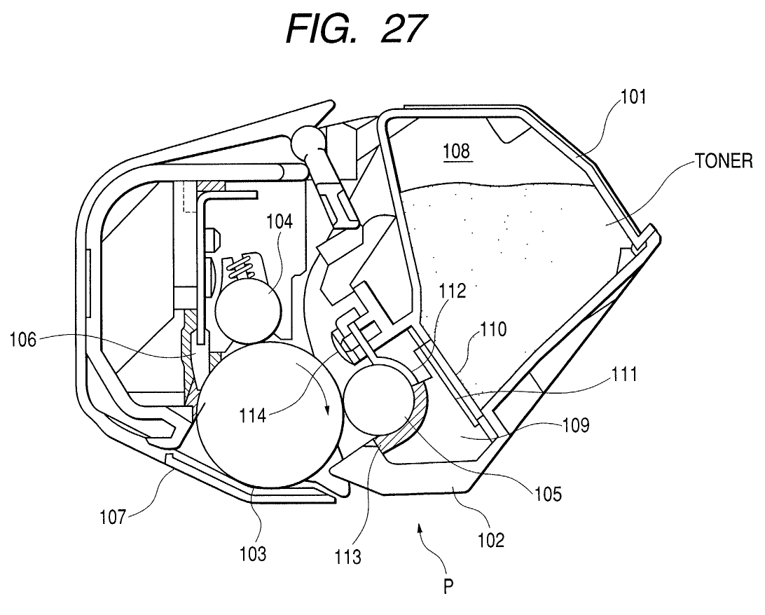

FIGS. 28A and 28B show the deformed states of a frame when the cartridge is grasped by a hand.

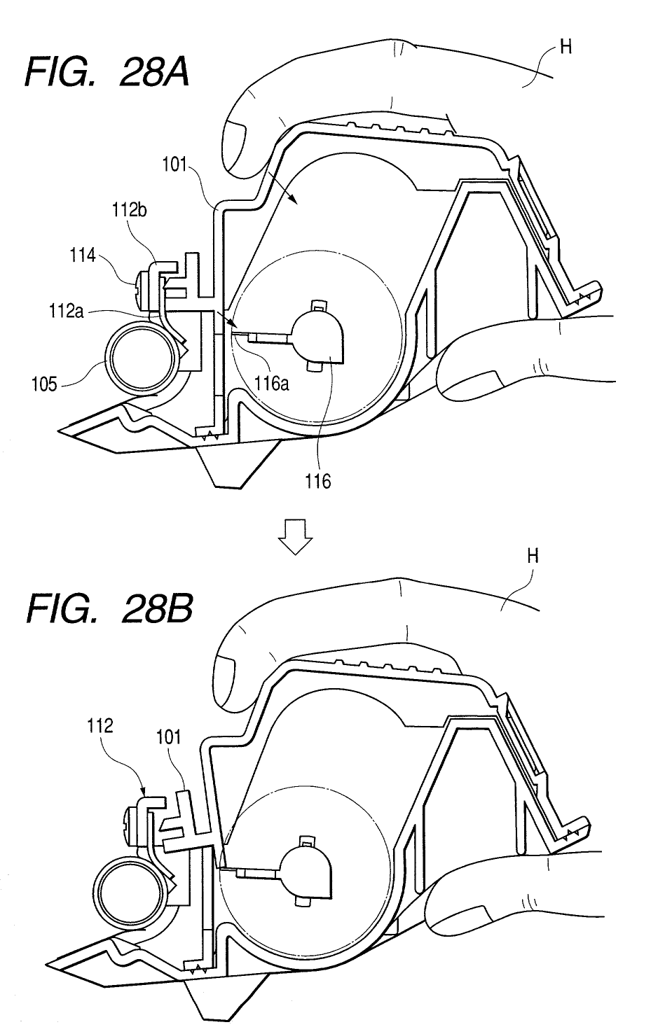

FIG. 29 is an exploded view and an assembled view of a toner container.

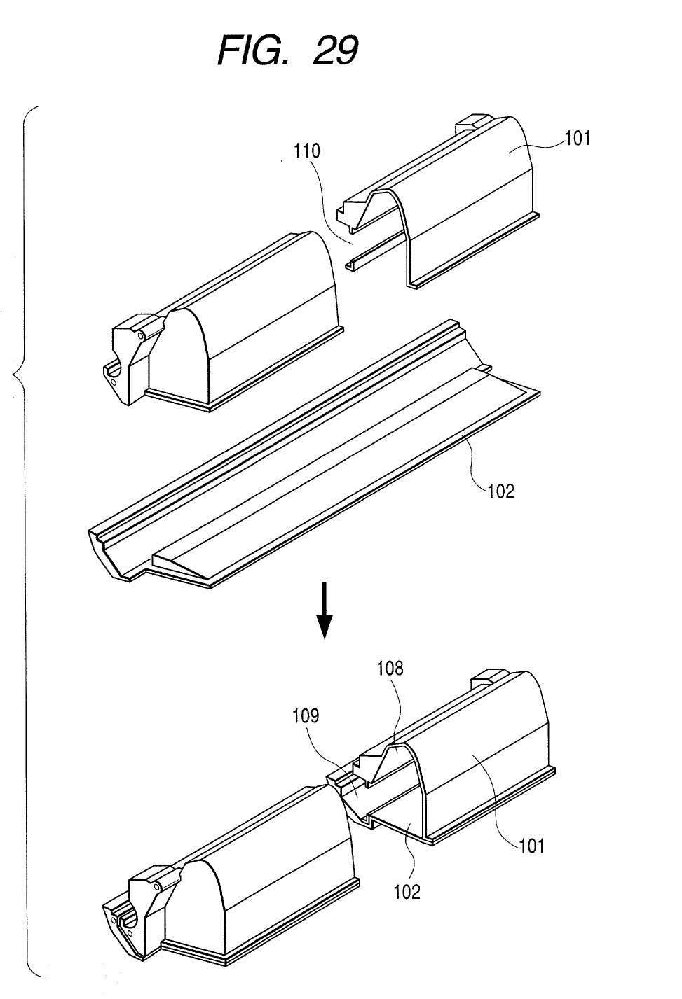

### DETAILED DESCRIPTION OF THE PREFERRED EMBODIMENTS

An embodiment of the present invention will hereinafter be described in detail with reference to the drawings. In the following description, the lengthwise direction of a process cartridge is a direction intersecting with (substantially orthogonal to) the transport direction of a recording medium. Also, left or right is left or right as the recording medium is viewed from above in accordance with the transport direction of the recording medium. Also, the upper surface of the process cartridge is a surface overlying in a state in which the process cartridge is mounted on the main body of an apparatus, and the underside of the process cartridge is an underlying surface.

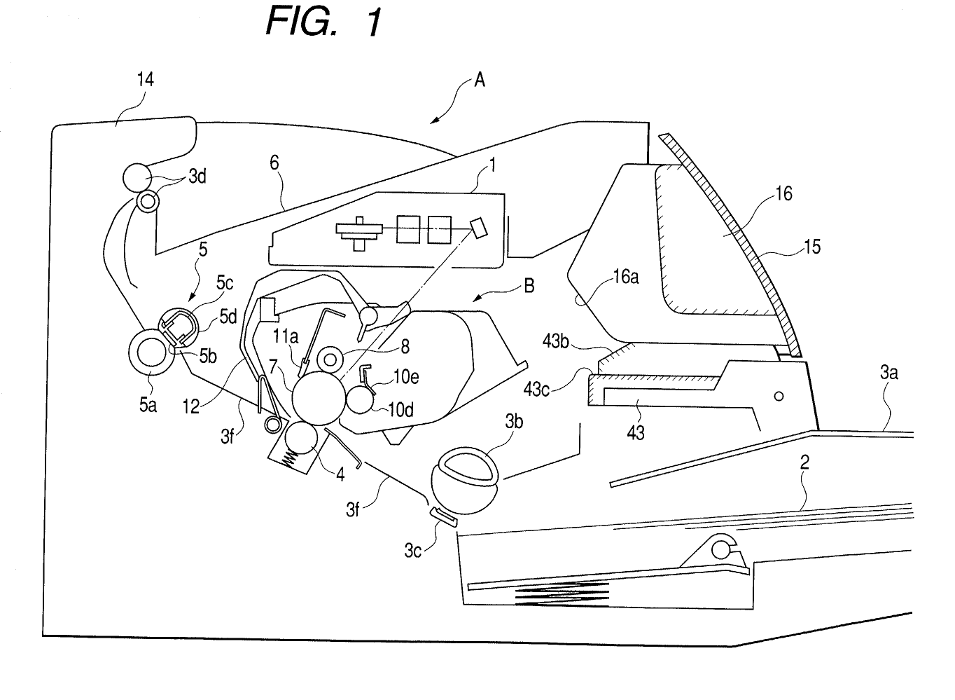

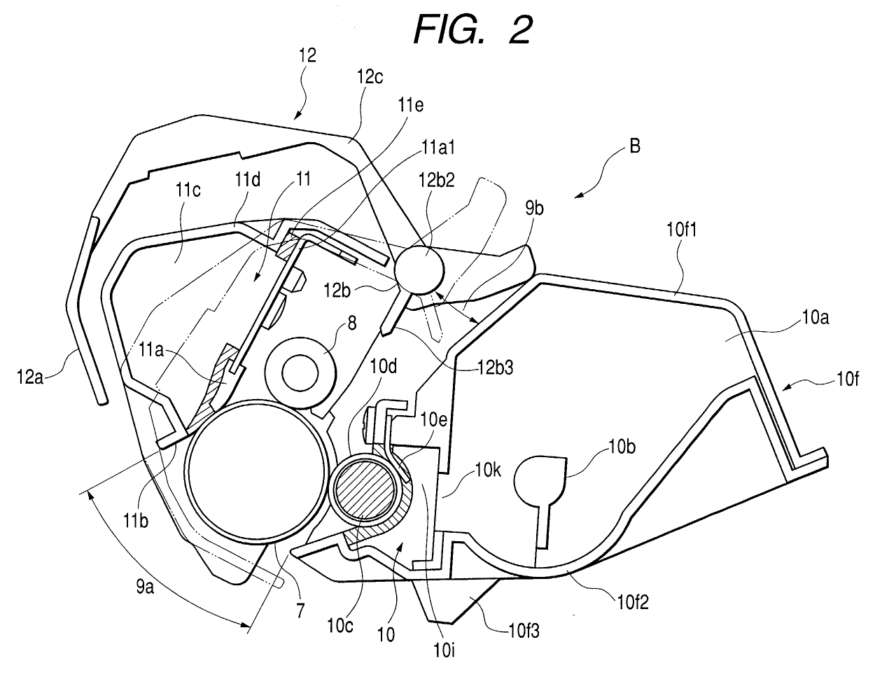

The process cartridge and an electrophotographic image forming apparatus having it mounted thereon will first be specifically described with reference to FIGS. 1 and 2. FIG. 1 is a typical illustration of the construction of the electrophotographic image forming apparatus having the process cartridge mounted thereon, and FIG. 2 is a typical illustration of the construction of the process cartridge. Herein, as the order of description, the process cartridge and the general construction of the electrophotographic image forming apparatus using the same will first be described, and then the construction of a process cartridge mounting and dismounting mechanism for mounting and dismounting the process cartridge on and from the main body of the electrophotographic image forming apparatus will be described.

(General Construction)

This electrophotographic image forming apparatus (laser beam printer, hereinafter referred to as the “image forming apparatus”) A, as shown in FIG. 1, applies image light based on image information from an optical system 1 as optical means to a drum-shaped electrophotographic photosensitive member (image bearing member, hereinafter referred to as the “photosensitive drum”) 7 to thereby form an electrostatic latent image on the photosensitive drum 7, and develops this electrostatic latent image by a developer (hereinafter referred to as the “toner”) to thereby form a toner image. Then, in synchronism with the formation of the toner image, recording mediums (such as recording paper, OHP sheets or cloth) 2 are separated and fed one by one from a cassette 3a by a pickup roller 3b and a pressure contact member 3c being in pressure contact therewith, and a voltage is applied to a transfer roller 4 as transferring means to thereby transfer the toner image formed on the photosensitive drum 7 in the process cartridge B to the recording medium 2, which is transported to fixing means 5 by a transport guide 3f. This fixing means 5 comprises a driving roller 5a and a fixing rotary member 5d containing a heater 5b therein and comprised of a cylindrical sheet rotatably supported by a support member 5c, and applies heat and pressure to the passing recording medium 2 to thereby fix the transferred toner image. This recording medium 2 is transported by delivery rollers 3d and is delivered to a delivery portion 6 through a surface reverse transport path. In the present embodiment, transporting means 3 is constituted by the pickup roller 3b, the pressure contact member 3c, the delivery rollers 3d, etc.

(Process Cartridge)

On the other hand, the process cartridge B is provided with the electrophotographic photosensitive member and at least one process means. As the process means, there are, for example, charging means for charging the electrophotographic photosensitive member, developing means for developing the electrostatic latent image formed on the electrophotographic photosensitive member, cleaning means for removing any toner residual on the electrophotographic photosensitive member, etc. The process cartridge B of the present embodiment is designed such that as shown in FIG. 2, the photosensitive drum 7 which is an electrophotographic photosensitive member having a photoconductive layer is rotated, and a voltage is applied to a charging roller 8 which is charging means to thereby uniformly charge the surface of the photosensitive drum 7, and this charged photosensitive drum 7 is exposed to image light (optical image) based on the image information from the optical system 1 through an exposure opening 9b to thereby form an electrostatic latent image on the surface of the photosensitive drum 7, and this electrostatic latent image is developed by developing means 10.

The developing means 10 feeds the toner in a toner containing portion 10a by a rotatable feed member 10b which is toner feeding means. The developing roller 10d which is a developing rotary member (developer carrying member) containing a stationary magnet 10c therein is rotated and also, a toner layer having triboelectrification charges induced therein by a developing blade 10e for regulating the layer thickness of the toner carried on the developing roller 10d is formed on the surface of the developing roller 10d, and the toner is shifted to the photosensitive drum 7 in conformity with the electrostatic latent image to thereby form a toner image as a visible image.

A voltage opposite in polarity to the toner image is applied to the transfer roller 4 to thereby transfer the toner image to the recording medium 2, where after any residual toner on the photosensitive drum 7 is removed by cleaning means 11 for scraping off the toner residual on the photosensitive drum 7 by a cleaning blade 11a, and also dipping the toner by a dip sheet 11b and collecting the toner into a removed toner containing portion 11c.

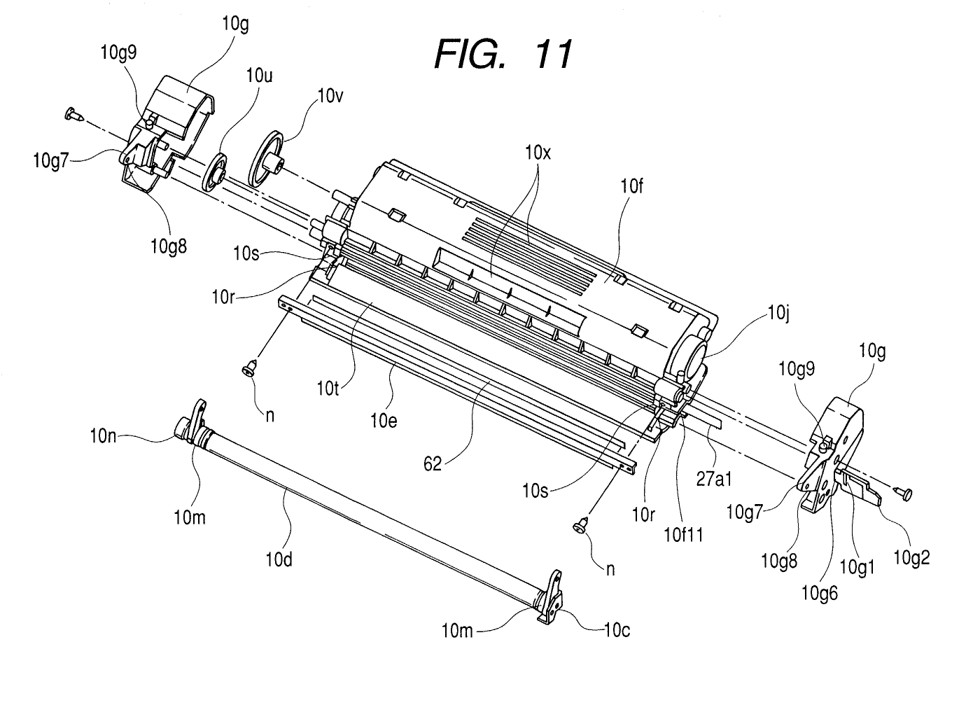

The process cartridge B shown in the present embodiment comprises a cleaning frame 11d (second part) which rotatably supports the photosensitive drum 7 and into which the cleaning means 11 and the charging roller 8 are incorporated, and a toner developing frame 10f (first part) into which the developing means 10 and the toner containing portion 10a are incorporated. The toner developing frame 10f is supported for pivotal movement relative to the cleaning frame 11d so that the developing roller 10d of the developing means 10 can be opposed to the photosensitive drum 7 in parallelism to the latter with a predetermined interval therebetween, and spacers 10m (see FIG. 11) for maintaining the interval between the developing roller 10d and the photosensitive drum 7 are disposed at the opposite end portions of the developing roller 10d. There are holder members 10g on the opposite sides of the toner developing frame 10f, and they have arm portions 10g7 formed with coupling holes 10g8 for rotatably suspending a developing unit on a cleaning unit. A predetermined pressure force is applied to between the developing unit and the cleaning unit to maintain an interval therebetween.

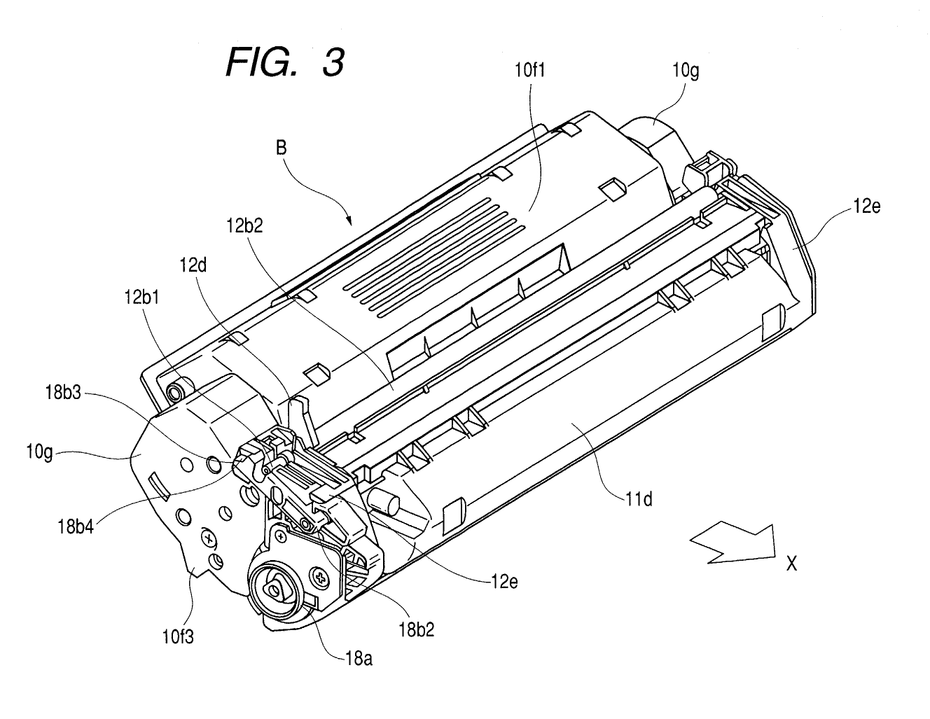

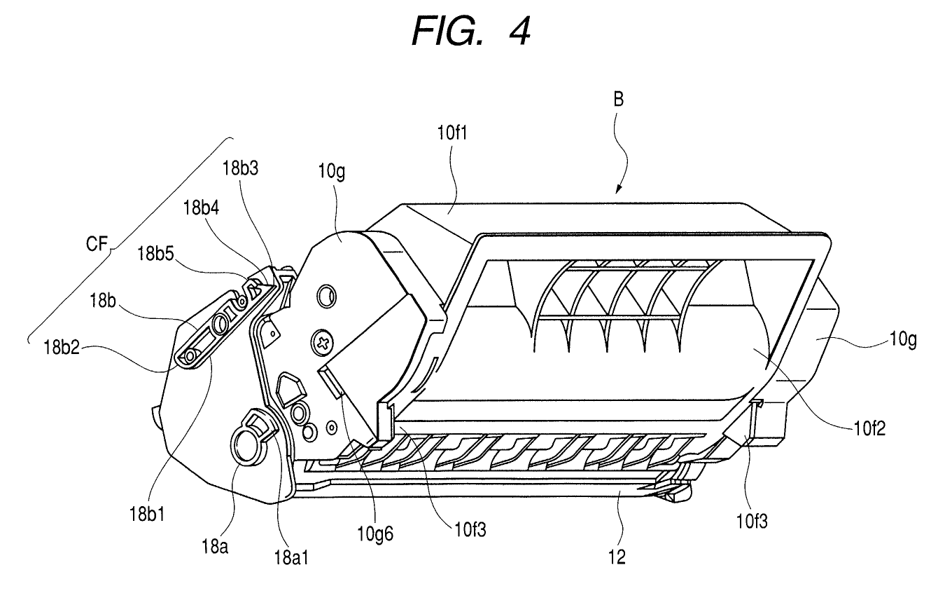

The frame CF of the process cartridge B comprises the toner developing frame 10f (first past) comprising a developing frame 10f1 and a lid member 10f2 welded together into a unit and the cleaning frame 11d (second part) coupled together. As shown in FIGS. 3 and 4, on the lengthwisely opposite sides of this cartridge frame CF, there are provided a mounting guide 18b for detachably mounting the process cartridge in the direction indicated by the arrow X to the main body 14 of the electrophotographic image forming apparatus (hereinafter referred to as the main body 14 of the image forming apparatus), and a positioning portion 18a present coaxially with the rotary shaft of the photosensitive drum 7 and supported by positioning means in the interior of the image forming apparatus. The positioning portion 18a is a cylindrical boss differing in diameter at the left and right thereof, and the positioning portion thereof on the anti-driving side has an arcuate projected portion 18a1 having the center on the rotary shaft of the photosensitive drum 7 and having a radius larger than that of the positioning portion 18a. The mounting guide 18b has an underside 18b1 received by a movable guide 41 which will be describe later, and a distal end portion 18b2 which is the distal end of the mounting guide 18b in the direction of insertion of the process cartridge, and this distal end portion 18b2 is made such that the curvature of the arc thereof connected to the underside 18b1 is greater than the curvature of the arc thereof connected to the upper surface. A slope portion 18b4 having its contained angle with the underside 18b1 made acute is formed on the lower corner of the rear end which is the corner of the rear end of the underside 18b1 in the direction of invention, and the rear end portion of the upper surface in the direction of insertion comprises an orthogonal surface 18b5 orthogonal to the upper surface. The rear end of the mounting guide 18b extends to the rear of the centroidal position of the process cartridge so that whenever the process cartridge B is supported by the mounting guide 18b, it may maintain a forwardly downwardly facing posture. In the present embodiment, the mounting guide 18b is provided on a side of the cleaning frame 11d and above the positioning portion 18a. The mounting guide 18b, however, may be provided on the toner developing frame 10f or a holder member 10g attached to a side thereof.

In the process cartridge B of the present embodiment, a drum shutter 12 capable of integrally covering the transfer opening 9a and exposure opening 9b of the photosensitive drum which are opposed to the transfer roller 4 is rotatably provided on the cleaning frame 11d. The construction of the drum shutter 12 will now be described. The drum shutter 12 has a drum protecting portion 12a capable of covering the transfer opening 9a through which the photosensitive drum 7 contacts with the transfer roller 4. On the rotary shaft 12b of the cleaning frame 11d which is to be rotatably supported near the exposure opening 9b, there are provided sliding portions 12b1 sliding relative to the cleaning frame 11d at the opposite ends of the rotary shaft 12b, a large-diametered portion 12b2 thicker than the sliding portions 12b1 in a portion connecting the sliding portions 12b1 at the opposite ends together and hanging on the exposure opening 9b, and an exposure shutter portion 12b3 for covering the exposure opening when the drum shutter 12 is closed on the large-diametered portion 12b2. The drum shutter 12 has connecting portions 12c provided at two left and right locations for connecting the opposite end portions of the drum protecting portion 12a and the large-diametered portion of the rotary shaft 12b outside thereof. It also has a cam portion 12d disposed on the right side of the large-diametered portion 12b2 of the rotary shaft 12b and protruding to the upper side of the process cartridge B. There is a rib 12e provided on the right connecting portion 12c and extending outwardly in the lengthwise direction of the drum shutter 12, and the rib 12e is received by the shutter guide 44c of a fixed guide 44, and the drum shutter 12 maintains its opened posture.

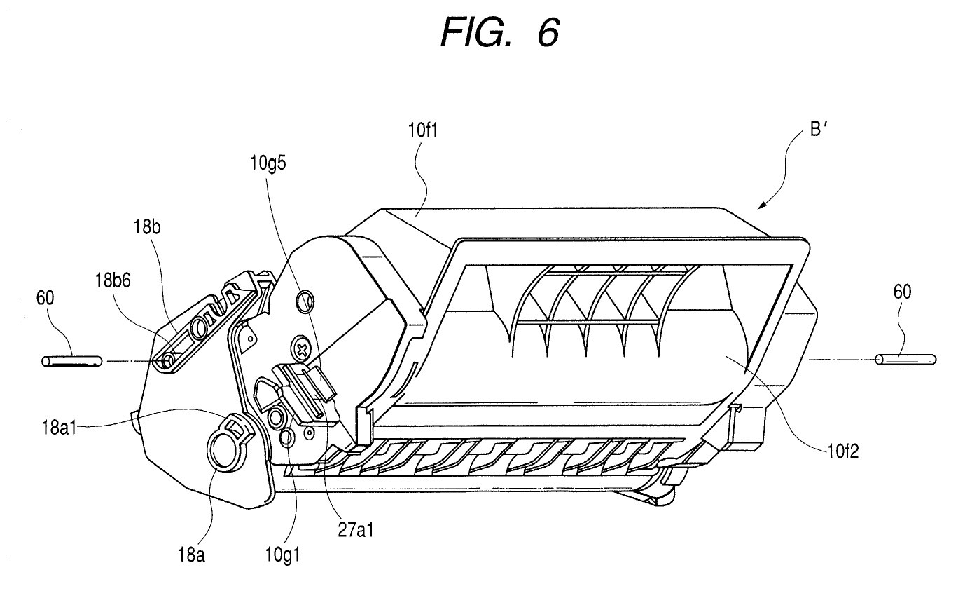

A biasing force is applied to this drum shutter 12 by the spring force of a shutter spring (see FIG. 6) in a direction in which the drum shutter 12 covers the photosensitive drum 7. Thereby, in a state in which the process cartridge B has been taken out of the main body of the apparatus, the drum shutter 12 maintains a state as indicated by double-dotted line in FIG. 2 wherein it is closed covering the transfer opening 9a of the photosensitive drum 7, and in a state in which the process cartridge B is in the main body of the apparatus and is capable of performing the image forming operation, the drum shutter 12 is rotated by drum shutter opening and closing means which will be described later, and assumes a posture as indicated by solid line in FIG. 2 wherein the transfer opening 9a is exposed and the photosensitive drum 7 and the transfer roller 4 become capable of contacting with each other therethrough.

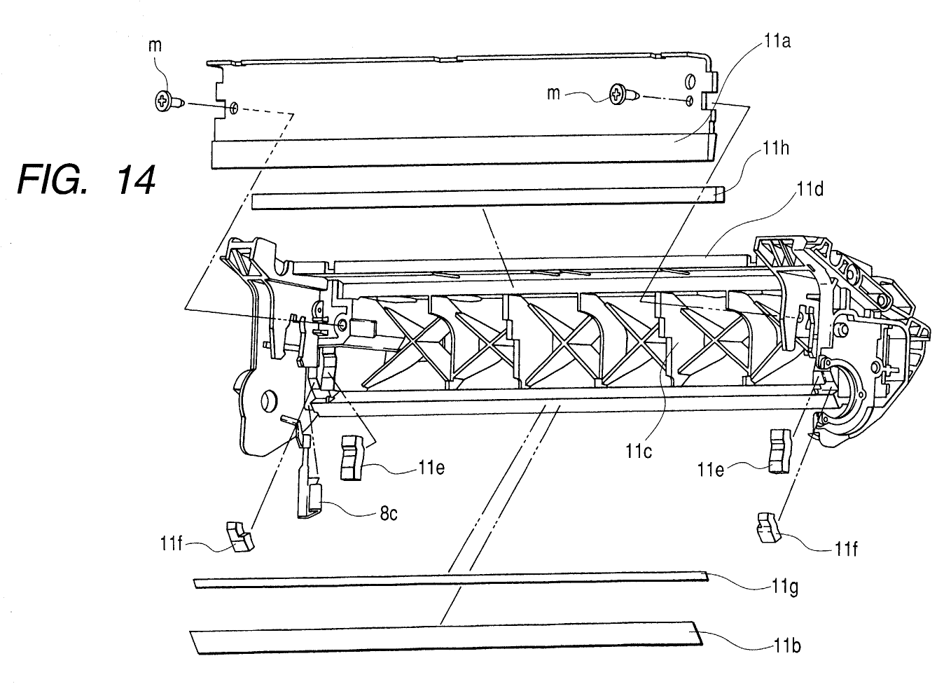

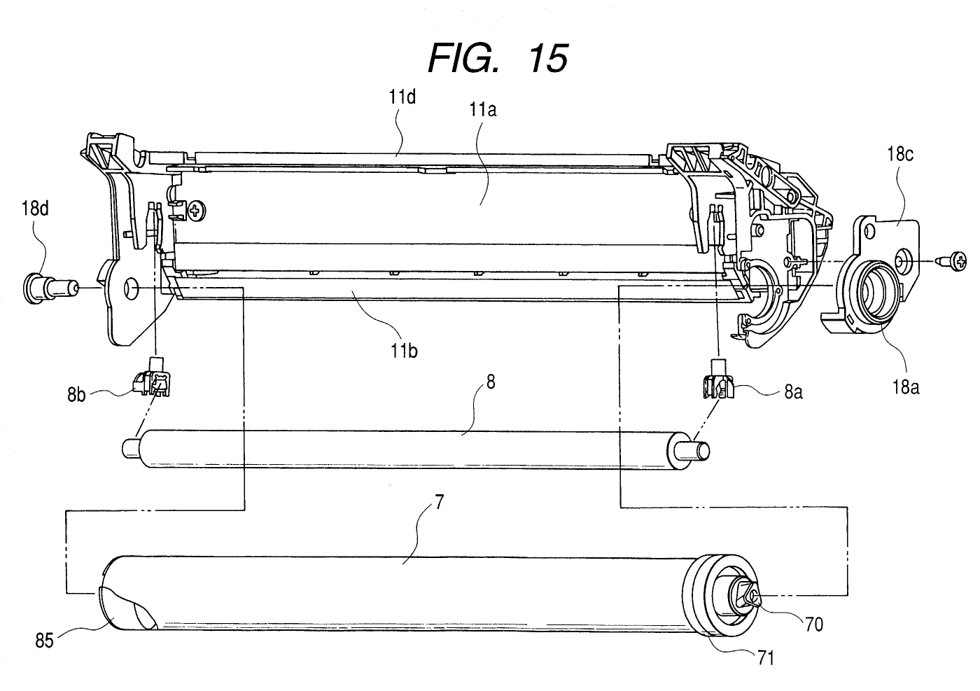

The procedure of assembling the cleaning frame 11d having the cleaning means will now be described in detail with reference to FIGS. 14 and 15. The assembling of the cleaning means 11 is effected in the same order as will be described hereinafter.

The cleaning means 11 is such that a first seal member 11e for preventing the leakage of the toner from the back of the opposite ends of the rubber of the cleaning blade 11a from the removed toner containing portion 11c and a second seal member 11h for preventing the leakage of the toner from the back of the cleaning blade are fixed to predetermined locations on the cleaning frame 11d as by a double-sided adhesive tape. The cleaning blade 11a is fixed to a predetermined location on the cleaning frame 11d by a screw m. Further, a third seal member 11f as a member for preventing the leakage of the toner from the opposite ends of the rubber of the cleaning blade 11a and wiping off extraneous matter such as the toner on the photosensitive drum 7, and a dip sheet 11b which is a dip member are fixed to the cleaning frame 11d as by a double-sided adhesive tape 11g. Also, an electrode 8c for supplying electric power from the main body A of the image forming apparatus to the charging roller 8 is fitted in the cleaning frame.

Further, a roller bearing 8b for supplying electric power from the electrode 8c to the charging roller 8 and providing a bearing and another bearing 8a are incorporated in the cleaning frame 11d, and the shaft portion of the charging roller 8 is fitted in the bearing 8b and 8a.

The photosensitive drum 7 has coupled to one end thereof a drive transmitting coupling 70 and a drum gear 71 comprising a gear for transmitting drive to the developing roller 10d and the transfer roller 4, an earth contact, etc. made integral with one another, and has coupled to the other end thereof a flange 85 having a bearing. The photosensitive drum 7 has a bearing 18c having the positioning portion 18a coupled to the coupling means 70 side thereof by a screw, and has the other end forced into and supported by the cleaning frame 11d so that a positioning pin 18d may be within the positioning portion 18a.

The developing means 10 in the process cartridge B will now be described in greater detail.

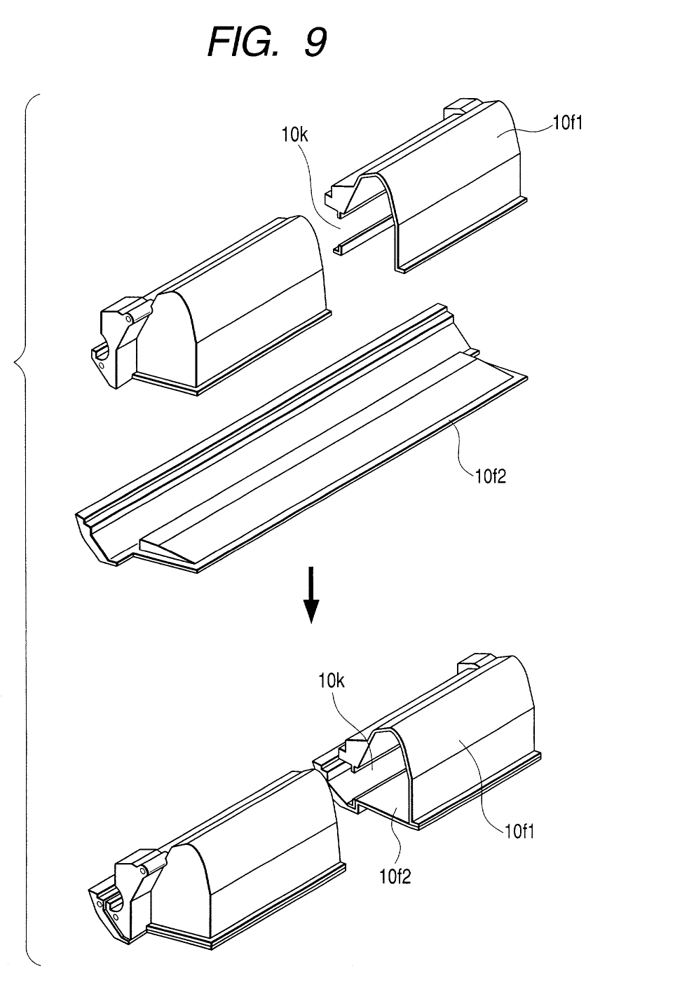

The developing means 10, as shown in FIGS. 2 and 9, is such that a toner developing frame 10f1 and a lid member 10f2 are coupled together to thereby constitute a toner chamber (toner containing portion) 10a and a developing chamber 10i.

Also, the toner developing frame 10f1 is formed with a toner passage opening 10k through which the toner contained in the toner chamber 10a passes when supplied to the developing roller 10d.

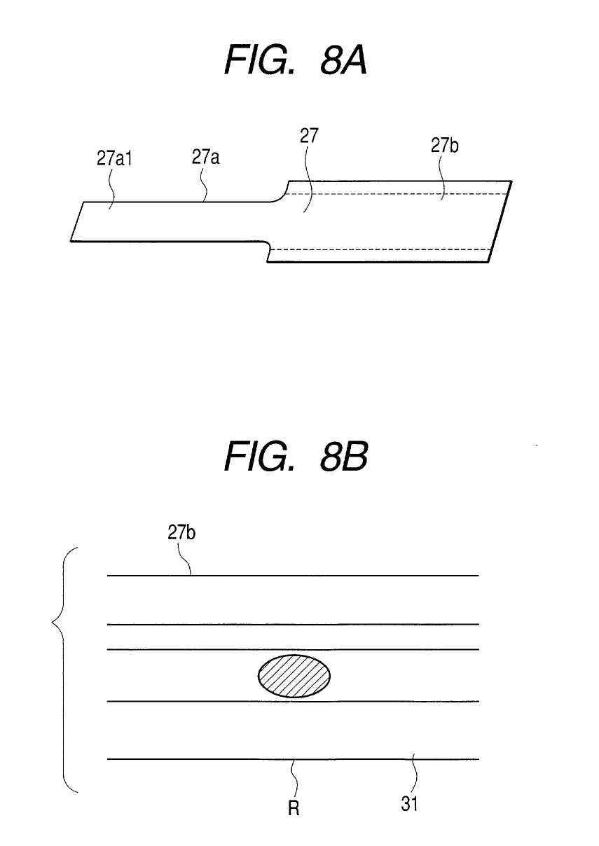

As shown in FIGS. 8A and 8B, a tearable cover film portion 27b is hot-welded by a laser beam to the seal mounting portion of a toner seal member 27 (see Japanese Patent Application Laid-Open No. 11-102105) comprising a plurality of layers closing the toner passage opening 10k of the toner developing frame 10f1, and this cover film portion 27b is provided with a sealant layer 31 for fixing the toner seal member 27.

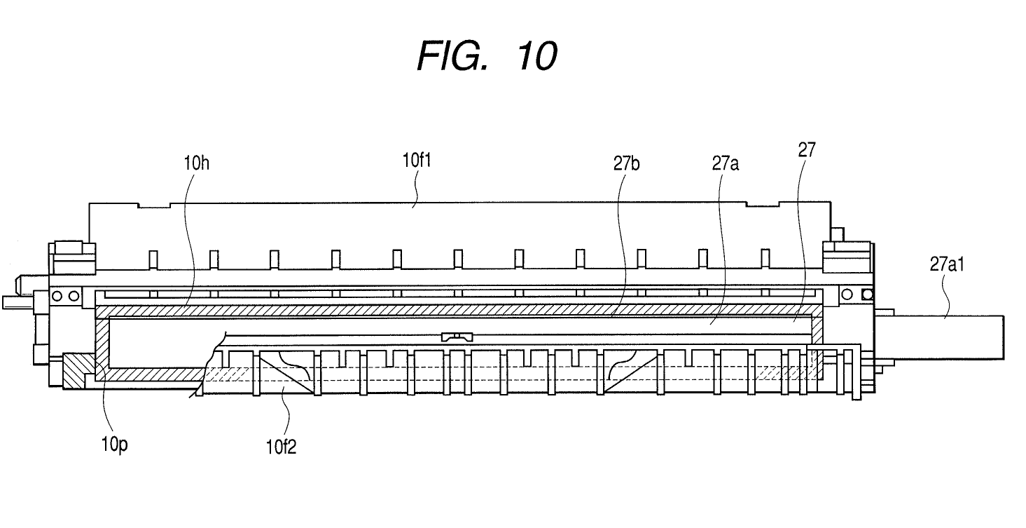

The toner seal member 27, as shown in FIG. 10, is stuck on the seal mounting portion 10h along the four side edges of the toner passage opening 10k, and this toner seal member 27 is half-cut-processed by the laser as previously described to unseal the toner passage opening 10k (Japanese Patent Application Laid-Open No. 11-102105).

Also, a toner pouring port (not shown) for pouring the toner into the toner chamber 10a therethrough is provided in lengthwise one end portion of the toner developing frame 10f1, and is sealed by a cap member 10j (see FIG. 11) after the toner has been poured.

The next assembling step will now be described with reference to FIGS. 9, 11 and 12. The developing means 10 is such that end portion seals 10r for preventing the leakage of the toner in the opposite end portions of the developing roller 10d, seal members 10s for preventing the leakage of the toner in the opposite end portions of the developing blade 10e, and a sheet member 10t for preventing the scattering of the toner from the gap in the lower portion of the developing roller 10d are stuck on the toner developing frame 10f1 and the lid member 10f2 by double-sided adhesive tapes or the like.

The developing blade 10e comprises an elastic blade 10e2 made of rubber and fixed to a metal plate 10e1 by an adhesive agent or a technique such as molding. A double-sided adhesive tape 62 for sealing the space between the elastic blade 10e2 of the developing blade 10e and that surface of the frame 10f1 on which the developing blade 10e is mounted is stuck on the aforementioned surface of the frame 10f1.

Thereafter the developing blade 10e has the opposite ends of its metal plate portion 10e1 fixed to the toner developing frame 10f1 by screws n. At this time, the tapered rib 66 of the toner developing frame 10f1 is set to such a dimension that it eats into the double-sided adhesive tape 62 which is an adhesive member having adhesive layers on both sides thereof and the rubber portion 10e2 of the developing blade without fail, and the rubber portion 10e2 and the toner developing frame 10f1 are sealed by the double-sided adhesive tape 62.

The length of the double-sided adhesive tape 62, as shown in FIG. 11, is substantially equal to the length of the elastic blade 10e2, and is somewhat smaller than the length between the two screws n at the opposite ends of the developing blade.

As described above, the double-sided adhesive tape is provided between the developing blade and the frame and therefore, even if the user grasps a grip 10x (FIG. 11) provided on the lengthwisely central portion of the frame 10f and a force is applied to the frame 10f, the frame 10f (10f1) will not separate from the developing blade, and it will be understood that the leakage of the toner and the deformation of the frame are suppressed. That is, the compatibility of the improved seal performance and the improved rigidity of the frame can be achieved by a very simple construction in which the double-sided adhesive tape is provided between the developing blade and the frame.

(Construction of the End Portion Members and the Handle Member)

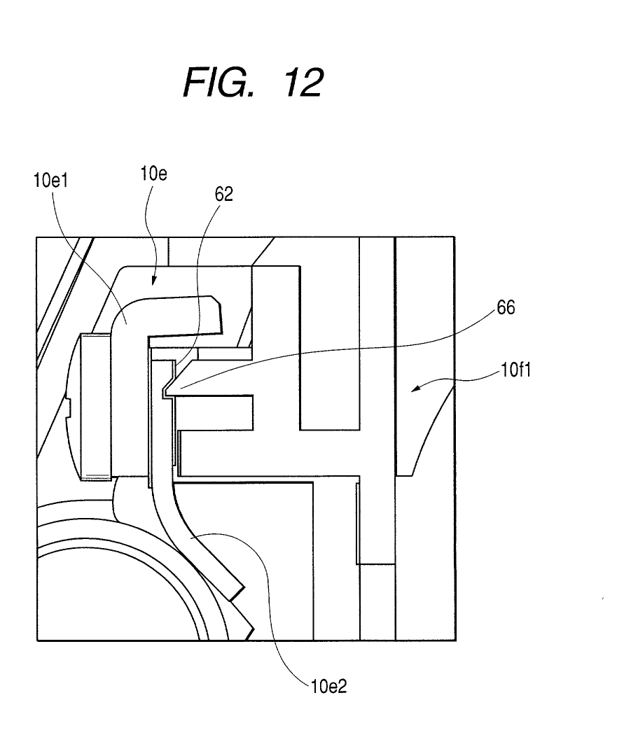

One of the end portion members (holder members), 10g, disposed on the lengthwisely opposite sides of the developing means 10 covers a gear train comprising a developing roller gear 10n (see FIG. 12) fixed to an end portion of the developing roller which is in meshing engagement with a drum gear (not shown) fixed to an end portion of the photosensitive drum 7, and two idler gears 10u and 10v for transmitting drive from the developing roller gear 10n to the transport gear (not shown) of the toner feed member 10b. Also, the other end portion member 10g is provided with a handle member 10g1 for stripping off a toner seal which will be described below.

The drawn-out portion 27a (see FIG. 8A) of a toner seal member 27 is turned back on lengthwise one end 10p (see FIG. 10) side of the toner passage opening 10k, and is drawn outwardly through an aperture 10f11 (see FIG. 11) in the toner developing frame 10f1. The end portion 27a1 of the drawn-out portion 27a of this toner seal member 27 which is drawn outwardly is further drawn outwardly through an aperture 10g6 in the end portion member 10g, and passes through a through-aperture 10g4 in a plate-shaped handle member 10g1 which provides a handhold so that the heat-fixable surface R (sealant layer 31 side) of the drawn-out portion 27a which is shown in FIG. 8B may become the handle member 10g1 side, and is heat-fixed to a predetermined side of the handle member 10g1 (see FIG. 6). The handle member 10g1 is provided detachably from the end portion member 10g. More particularly, the thickness of a connected portion connected to the end portion member 10g is made especially small so that it can be bent and separated. Also, the handle member 10g1 and the end portion member 10g are formed integrally with each other. Preferably, they may be formed integrally with each other by the use of a styrene-based material such as high impact polystyrene (HIPS) or acrylonitrile-butadiene polymer (ABS). The end portion 27a1 of the drawn-out portion 27a is heat-welded to this handle member.

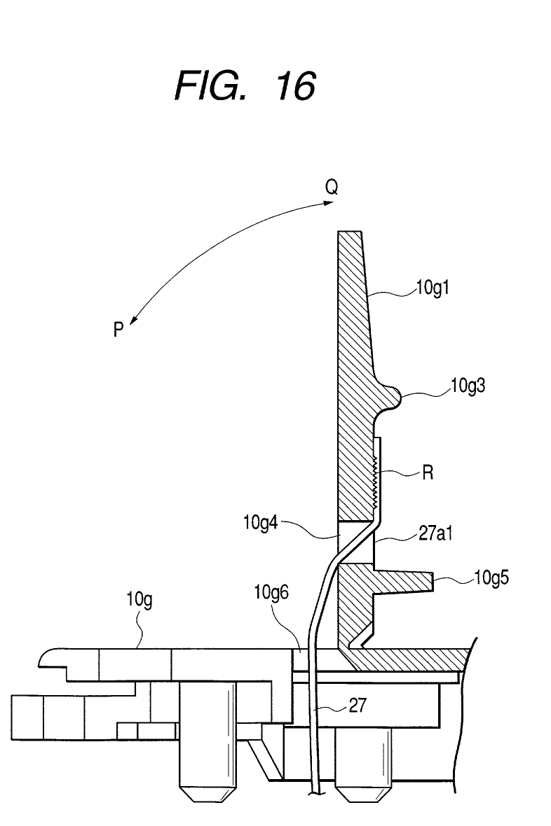

The process cartridge B′ shown in FIG. 6 which has been assembled as described above is shipped with the handle member 10g1 brought down in the direction indicated by the arrow P as shown in FIG. 16 so that it may be contained with the handle member 10g1 in a package. The tip end portion of the handle member 10g1 is provided with a relief portion (a cut-away 10g2 shown in FIG. 11) so that when brought down, it may not interfere with a projected portion 18a1 which is the positioning portion of the cleaning frame 11d.

Now, as previously described, the holder members (hereinafter referred to as the “end portion members”) 10g have arm portions 10g7 protruding toward the cleaning frame 11d, as shown in FIG. 11, and the cleaning frame 11d and the end portion members 10g can be pivotably coupled together by lengthwise coupling holes 10g8 formed in the tip ends of the arms 10g7 and pins 60 (see FIG. 6) fitted into coupling holes (not shown) formed in the cleaning frame 11d. Compression coil springs having their inner diameters fitted in spring snaps 10g9 on the arm portions 10g7 are compressedly provided between the arm portions and the cleaning frame 11d, and gap holding members (spacers) 10m at the opposite ends of the developing roller 10d are in pressure contact with the photosensitive drum 7.

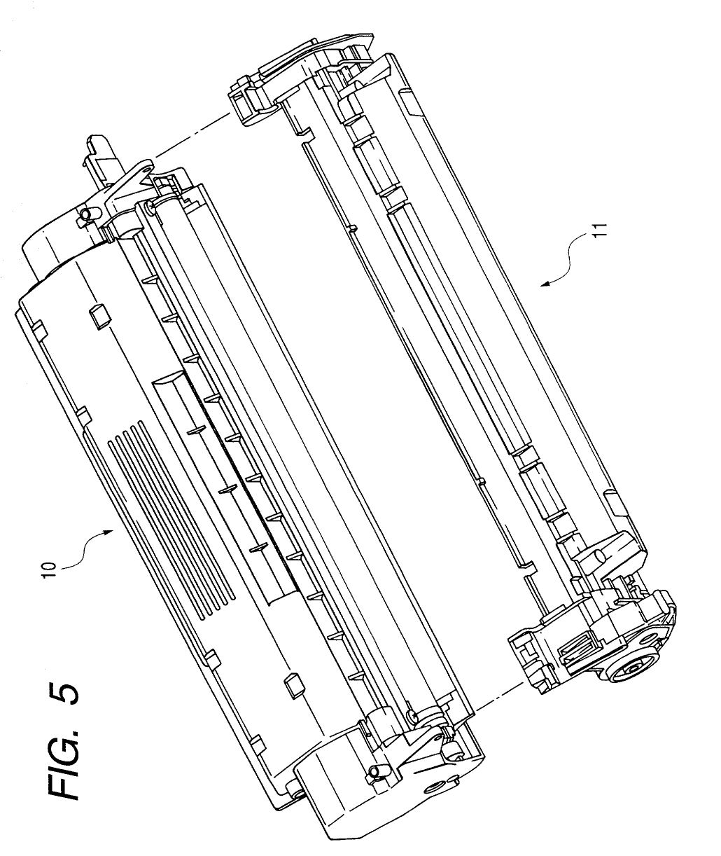

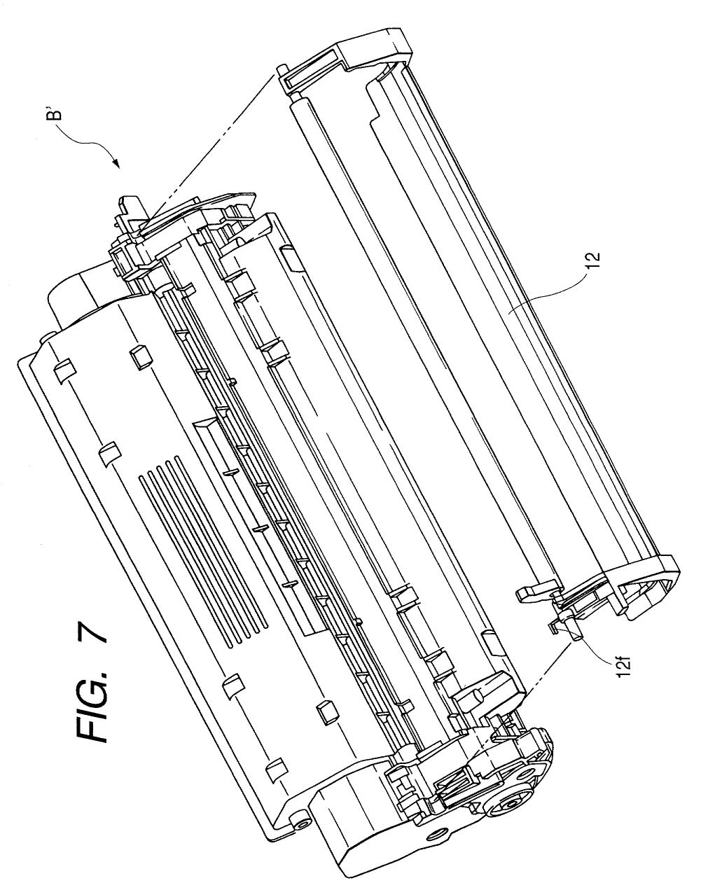

As shown in FIGS. 5, 6 and 7, the cleaning frame 11d having the photosensitive drum 7, the cleaning means 11, etc. assembled thereto is coupled to the toner developing frame 10f1 and the lid member 10f2 made integral with each other as described previously, by pins 60 being inserted through the holes 10g8 in the opposite end portion members 10g along pin insertion guides 18b6 provided inside the mounting guides 18b, and forced into apertures (not shown) in the cleaning frame which are coaxial with the pin insertion guides 18b6 on the opposite sides of the holes 10g8 in the end portion members 10g. Further, the shutter 12 and the shutter spring 12f are coupled to the cleaning frame 11d, whereby the process cartridge B′ is assembled.

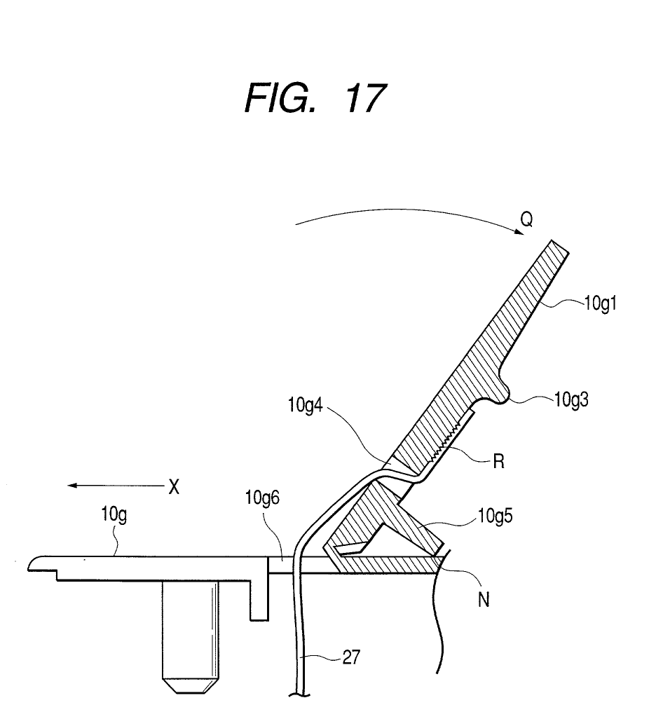

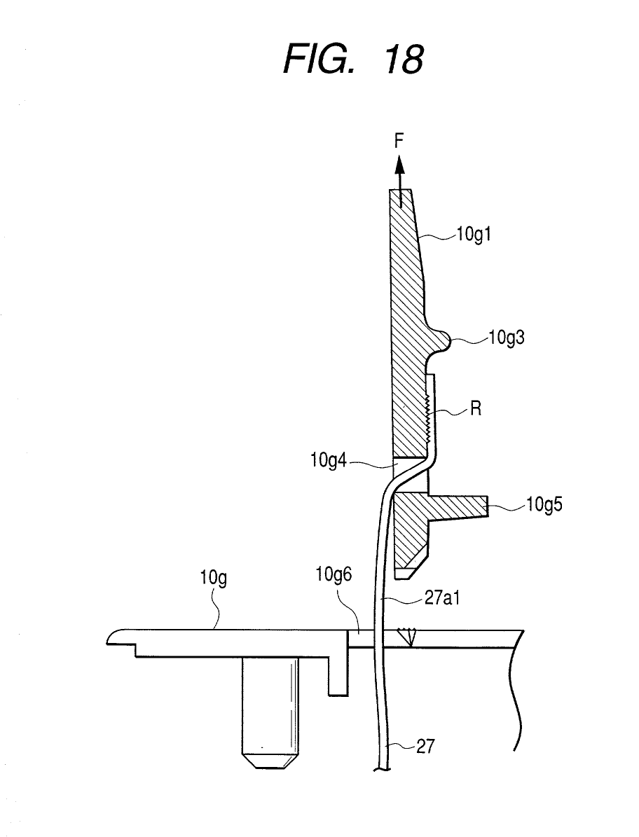

When the user brings down the handle member 10g1 in the direction indicated by the arrow Q opposite to the direction of insertion of the process cartridge B into the main body 14 of the image forming apparatus as shown in FIG. 17 when he purchases and uses the process cartridge, the tip end portion N of a projection 10g5 provided on the handle member 10g1 abuts against the end portion member 10g and becomes a rotation fulcrum, and the root side (the connected portion to the end portion member 10g) of the handle member 10g1 is separated from the end portion member 10g, and as shown in FIG. 18, the operator catches the convex portion 10g3 which is the handhold of the handle member 10g by his fingers and pulls it in the direction indicated by the arrow F, whereby the drawn-out portion 27a is pulled out and the cover film portion 27b is torn, and the toner passage opening 10k of the toner developing frame 10f1 is unsealed and thus, the toner becomes capable of being fed from the toner chamber 10a into the developing chamber 10i, and the process cartridge B assumes its state as shown in FIGS. 2 and 4 and becomes ready to be inserted into the main body 14 of the image forming apparatus.

(Process Cartridge Mounting and Dismounting Mechanism)

Description will now be made of the construction of a process cartridge mounting and dismounting mechanism for mounting and dismounting the process cartridge B on and from the main body 14 of the image forming apparatus.

The process cartridge mounting and dismounting mechanism in the present embodiment is comprised of a movable guide 41 for holding the process cartridge in the main body of the image forming apparatus and movable between the optical system and the transportation means, a cam plate 50 for moving the movable guide 41 at the first half of the closing operation of an opening and closing cover 15 and the second half of the opening operation thereof, a connecting plate 51 for transmitting the rotational movement of the opening and closing cover 15 to the cam plate 50, a push arm for supporting the process cartridge in a position in which it is capable of performing the image forming operation after the movement of the process cartridge, and drum shutter opening and closing means for the drum shutter 12 of the process cartridge.

Further, in the present embodiment, the process cartridge mounting and dismounting mechanism has drive connecting means for effecting the connection and disconnection between image forming apparatus side coupling means and process cartridge side coupling means 70 for transmitting drive from the lengthwisely right end portion to the process cartridge at the second half of the closing operation of the opening and closing cover and he first half of the opening operation thereof, and an interlock switch for detecting the closing of the opening and closing cover and operably supplying electric power to the image forming apparatus. In the closing operation of the opening and closing cover, the process cartridge is transported by the movement of the movable guide 41 operatively associated with the opening and closing cover, and next the coupling means is brought into the state of FIG. 1 in which the coupling means are connectable together by the drive connecting means and also, the push arm is operated, where after the interlock switch is operated. Design is made such that in the opening operation of the opening and closing cover, the interlock switch is released earlier and next, the drive connecting means and the push arm are released and lastly, the movable guide is moved.

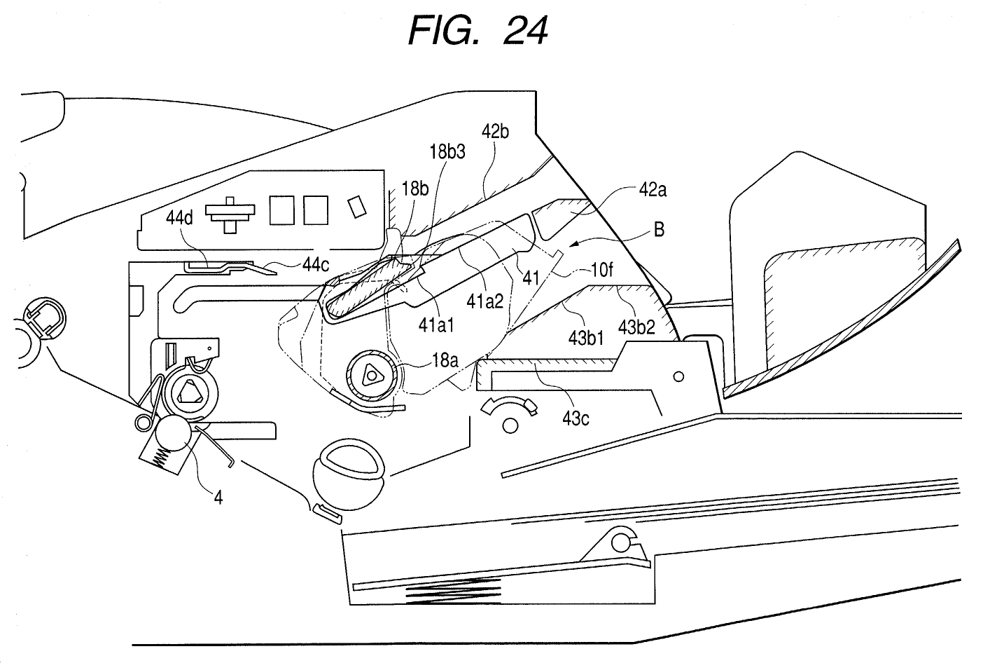

Also, the shutter 12 starts its opening operation by the cam portion 12d abutting against the support plate of the optical system 1 in the transport process of the process cartridge B by the movable guide 41 in the closing operation of the opening and closing cover 15, and as the opening operation progresses further, the rib 12e runs onto a shutter guide 44c, and further arrives at a shutter guide horizontal position 44d on the inner side (see FIG. 24), and the opened state is kept in the position of FIG. 1 which is an image forming position. In the opening operation of the opening and closing cover 15, the shutter 12 can be closed by a converse operation.

(Mounting of the Process Cartridge onto the Main Body)

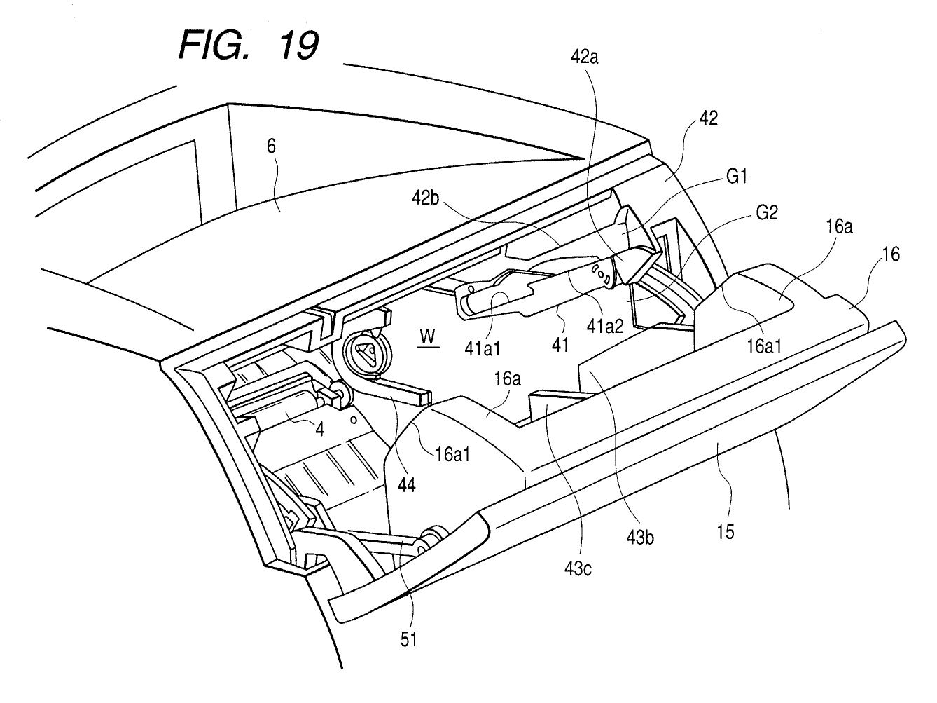

The mounting and dismounting operation for the process cartridge B by the process cartridge mounting and dismounting mechanism will now be described with reference to FIGS. 19 to 25A and 25B.

When the opening and closing cover 15 of the main body 14 of the image forming apparatus is completely opened (fully opened state), an opening W for mounting and dismounting the process cartridge therethrough appears. In this state, as shown in FIG. 19, the movable guide 41 appears in a posture in which it is lowered toward the inner side of the direction of insertion of the process cartridge. On the upstream side of the movable guide 41 with respect to the direction of insertion, auxiliary guides 42 are substantially symmetrically fixed to an inner plate 40 at left and right.

Each auxiliary guide 42 has a mounting and dismounting auxiliary portion 42a connecting to the rear end of the movable guide 41, and an upper regulating portion 42b having a surface substantially continuing to the upper surface 41a6 of the movable guide 41. The mounting and dismounting auxiliary portion 42a has a front guide surface 42a1 continuing to a guide surface 41a2, an introduction guide surface 42a2 continuing to the front guide surface 42a1 and looser in inclination than the front guide surface 42a1 and made substantially horizontal, and a lower guide surface 42a3 lying below the front guide surface 42a1 and the introduction guide surface 42a2 and sharper in inclination than the front guide surface and extending toward the underside of the movable guide 41. Also, the upper regulating portion 42b has an upper guide surface 42b1 substantially continuing to the upper surface 41a6 of the movable guide 41, and an upper introduction guide surface 42b2 continuing to the upper guide surface 42b1 and substantially parallel to the lower guide surface 42a3 and inclined upwardly from the upper guide surface 42b1. Also, the side guide 43b of a front guide 43 has an inclined surface 43b1 made somewhat sharper in inclination than parallelism to the guide surface 41a2 of the movable guide 41, and a horizontal surface 43b2 continuing to the inclined surface 43b1 and provided on the opening and closing cover 15 side.

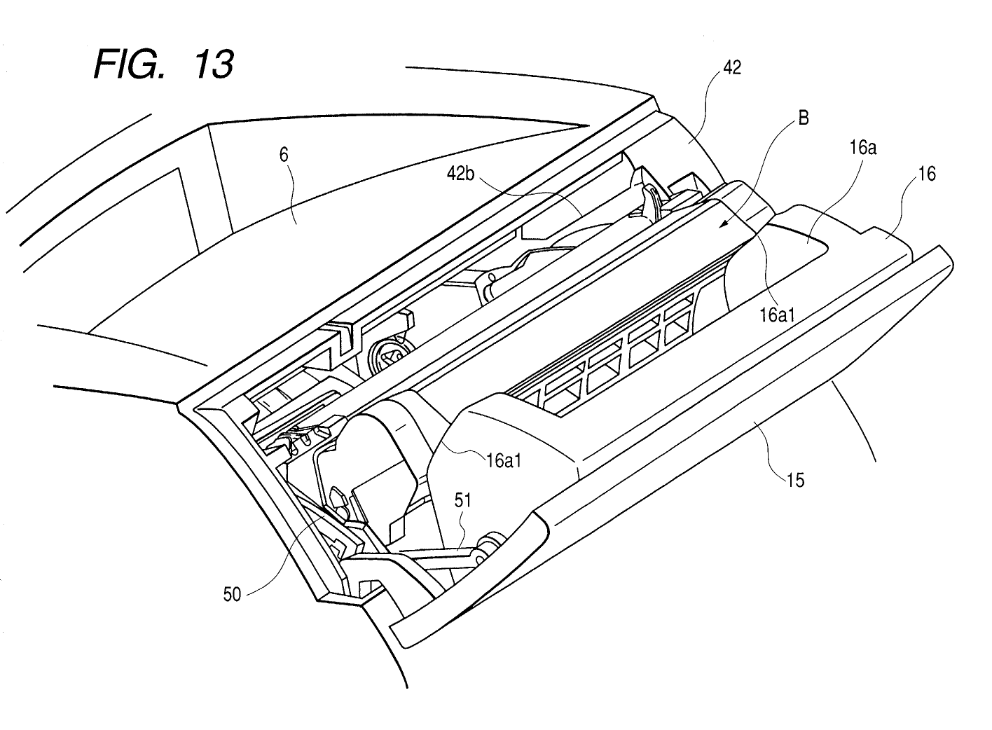

Therefore, on the inner surfaces of the left and right inner plates 40 of the opening W which appears with the opening and closing cover 15 opened, there appear two guide grooves, namely, an upper guide G1 having its entrance side widened by the introduction guide surface 42a2 and the upper introduction guide surface 42b2 and constructed among the upper regulating portion 42b and the mounting and dismounting auxiliary portion 42a of the auxiliary guide 42 and the movable guide 41, and a lower guide G2 having its entrance side widened by the lower guide surface 42a3 and the horizontal surface 43b2, and constructed among the mounting and dismounting auxiliary portion 42a and the movable guide 41 and the side guide 43b. Also, the opening and closing cover 15, as shown in FIG. 13, has its central boss 15a underlying the cover and therefore, the opening and closing cover 15 is opened downwardly and the back lid 16 faces the opening W. Convex portions 16a provided on the back lid 16 are formed with rough guide surfaces 16a1 inclined downwardly in the direction of insertion of the process cartridge.

The process cartridge B, as previously described, is provided with positioning portions 18a formed on the opposite sides of the cartridge frame CF coaxially with the rotary shaft of the photosensitive drum 7, and a rib-shaped mounting guide 18b formed along the direction of mounting and dismounting of the process cartridge. Further, projected portions 10f3 are provided on the underside of the toner developing frame 10f near the lengthwisely opposite ends thereof.

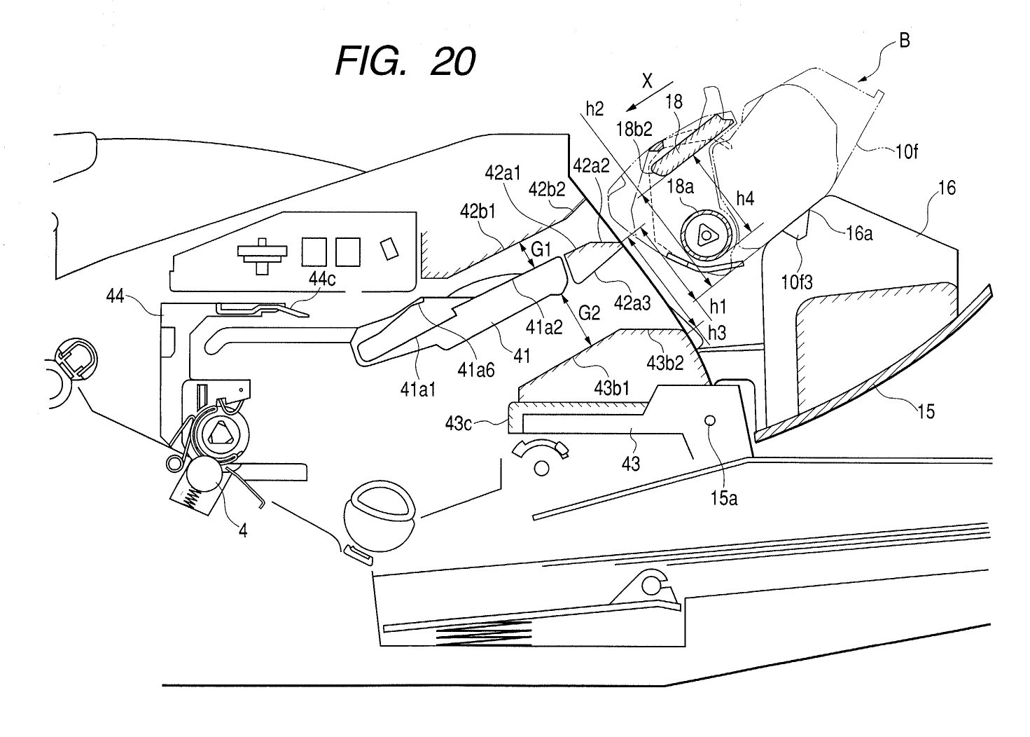

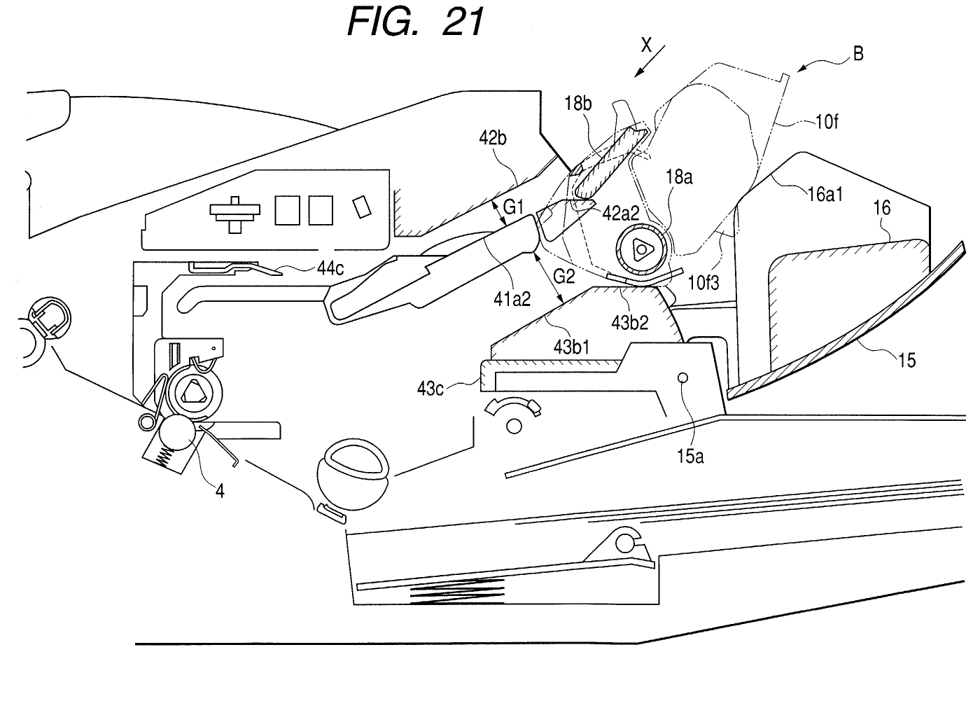

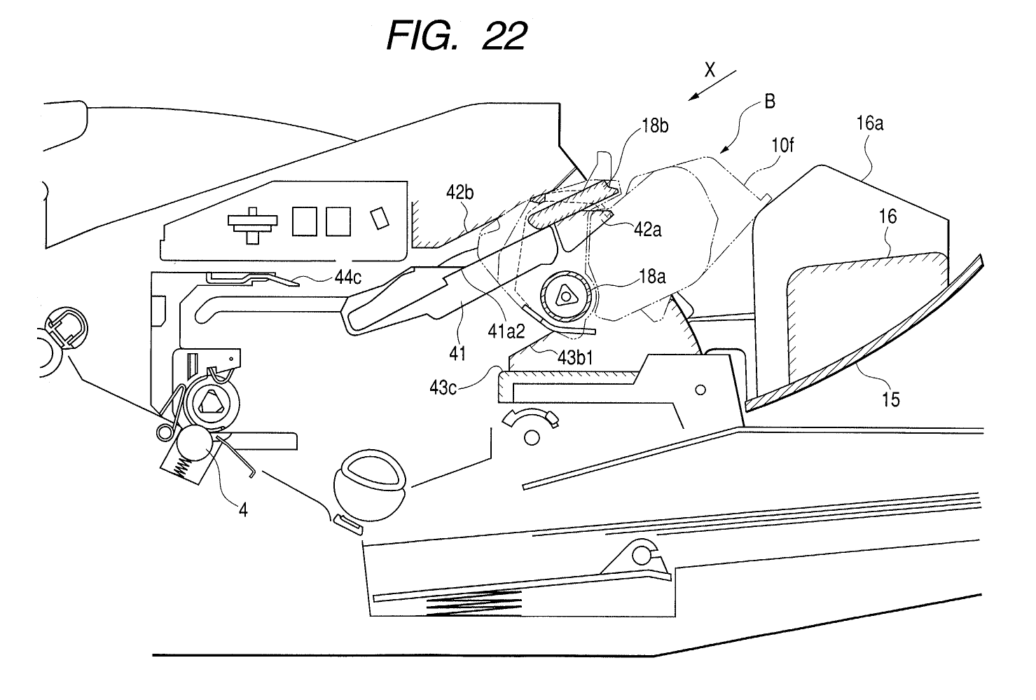

When the user is to grasp the grip 10x of the cartridge and insert the process cartridge B into the opening W, he inserts the mounting guide 18b of the process cartridge B into the upper guide G1 on the side of the opening W with the positioning portion 18a adjusted to the lower guide G2 until the mounting guide 18b strikes against the inner part of the guide groove 41a of the movable guide 41. At this time, the convex portions 16a of the back lid 16 act as rough guides for restricting the inserted position of the process cartridge B to a certain degree, and making the mounting guide 18b and positioning portion 18a of the process cartridge easy to direct to the upper guide G1 and the lower guide G2, respectively. This is designed such that the distance h1 from the rough guide surface 16a1 to the opening and closing cover side vertex of the introduction guide surface 42a2 and the distance h2 from the underside of the toner developing frame 10f to the point of intersection between the underside 18b1 and the tip end portions 18b2 of the mounting guide 18b are set to h1<h2, and the distance h3 from the opening and closing cover side vertex of the introduction guide surface 42a2 to the opening and closing cover side vertex of the horizontal surface 43b2 of the side guide 43b and the distance h4 from the point of intersection between the underside 18b1 and the tip end portion 18b2 of the mounting guide 18b to the underside of the positioning portion 18a are set to h3>h4, whereby when as shown in FIGS. 20 and 21, the underside of the toner developing frame 10f is disposed along the rough guide surface 16a1 provided on the upper surfaces of the convex portions 16a, the mounting guide 18b and the positioning portion 18a are naturally guided to the entrance of the upper guide G1 and the entrance of the lower guide G2, respectively. Also, the convex portions 16a, as shown in FIG. 22, contact with the rear end of the toner developing frame 10f until the mounting guide 18b comes to the guide surface 41a2 of he movable guide 41, and the process cartridge B is maintained in its forwardly downwardly facing posture in the mounting directions and therefore, the process cartridge B is made easy to move to the inner part of the guide groove 41a of the movable guide 41 with the aid of gravity.

It is for securing a space for permitting the user's hand to reasonably come thereinto during the mounting or dismounting of the process cartridge or during jams treatment that the convex portions 16a are provided near the lengthwisely opposite end portions of the back lid 16 and is made low in the central portion thereof, and this is a shape for the opening W appearing with the opening and dosing cover 15 opened to satisfy both of a restricted area for the mounting of the process cartridge and a space for permitting the user to easily have access to the interior of the image forming apparatus.

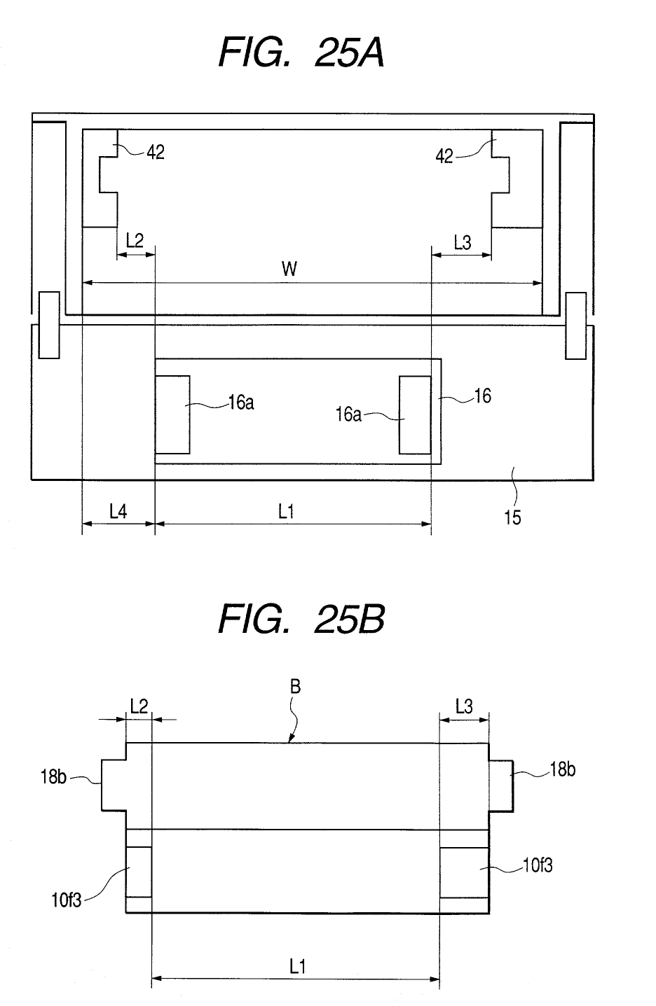

The positional relation between the convex portions 16a in the opening W and the process cartridge in the lengthwise direction thereof will now be described with reference to FIGS. 25A and 25B. The relations of the interval 11 between the inner sides of the projected portions 10f3 of the process cartridge B. the interval 12 between the inner side of the left projected portion and the left side of the cartridge frame CF, and the interval 13 between the inner side of the right projected portion and the right side of the cartridge frame CF to the interval L1 between the outer sides of the convex portions 16a of the back lid 16, the interval L2 between the outer side of the left convex portion and the inner surface of the left auxiliary guide, and the interval L3 between the outer side of the right convex portion and the inner surface of the right auxiliary guide are (1)L1<l1, (2)L2 [symbol] l2+(l1−L1)/2+((L1+L2+L3)(l1+l2+l3))/2 and (3)L3 [symbol] l3+(l1−L1)/2+((L1+L2+L3)−(l1+l2+l3))/2 and therefore, from expression (1), the convex portions 16a at the opposite ends are between the projected portions 10f3 on the underside of the toner developing frame, and from expressions (2) and (3), the projected portions 10f3 are adjusted to the convex portions 16a, whereby the rough lengthwise alignment of the process cartridge B with the opening W can be done.

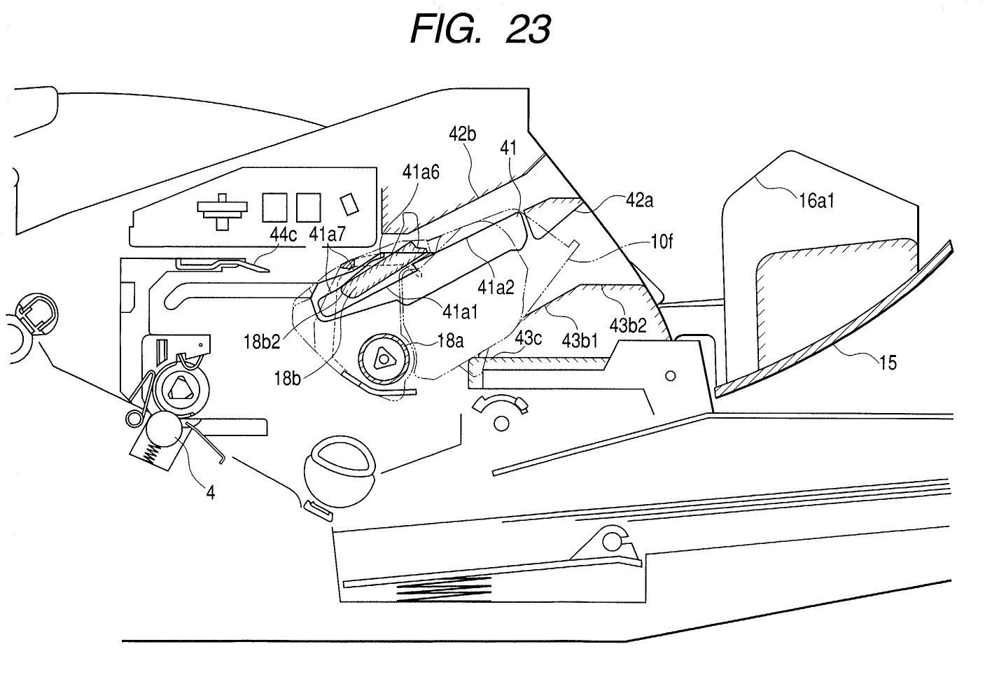

When by the utilization of the thus formed convex portions 16a of the back lid 16, the mounting guide 18b and the positioning portion 18a of the process cartridge B are guided to the upper guide G1 and the lower guide G2, respectively, the process cartridge assumes its forwardly downwardly facing posture because the front guide surface 41a1 which is the underside of the upper guide G1 and the guide surface 41a2 are formed while being forwardly downwardly inclined and the rear end of the mounting guide 18b is provided up to the rear of the centroidal position of the process cartridge, and the process cartridge B is adapted to be guided to the inner part of the movable guide 41 with the aid of gravity. The inclined surface 43b1 of the side guide 43b which is the underside of the lower guide G2 is somewhat steeper in inclination than the guide surface 41a2 and therefore, as the process cartridge is inserted, the positioning portion 18a separates from the inclined surface 43b1 of the side guide 43b (see FIG. 22). Thus, the process cartridge, when inserted through the opening W, is designed to receive the mounting guide 18b by the movable guide 41. As the process, cartridge B received by the guide surface 41a2 of the movable guide 41 is further inserted, the tip end portion 18b2 of the mounting guide 18b abuts against the upper inclined surface 41a7 of the movable guide 41 (see FIG. 23). The tip end portion 18b2 of the mounting guide 18b is a smooth arc, and the lower side of the upper inclined surface 41a7 is a receiving surface (front guide surface) 41a1 lower than the guide surface 41a2 and therefore, the process cartridge B is inserted into the inner part of the guide groove 41a while changing its posture in a direction to further steepen its inclination than during the mounting thereof by the action of the upper inclined surface 41a7, and the tip end portion 18b2 of the mounting guide comes into contact with the inner part of the receiving surface 41a1, whereupon the mounting of the process cartridge is completed (see FIG. 24).

When the process cartridge B changes its posture to the posture in the direction to steepen its inclination, the tip end of an abutting rib 43c provided on the front guide 43 abuts against the underside of the toner developing frame 10f, and with the tip end of this abutting rib 43c as a fulcrum, the process cartridge B changes to a further forwardly downwardly facing posture (see FIGS. 23 and 24). The point at which the underside of the toner developing frame 10f contacts with the abutting rib 43c with the process cartridge B completely inserted is set rearwardly of the centroidal position of the process cartridge B with respect to the direction of insertion and therefore, the process cartridge assumes a posture in which it raises the toner developing frame which is the rear side in the direction of insertion upon completion of the mounting thereof. Therefore, the process cartridge B inserted through the opening W has the underside of the tip end portion 18b2 of the mounting guide supported by the inner part of the receiving surface 41a1 of the guide groove 41a and has the underside of the toner developing frame 10f supported by the abutting rib 43c of the front guide 43, and the lower corner 18b3 of the rear end of the mounting guide 18b is raised. The abutting rib 43c is set such that the lower corner 18b3 of the rear end of the mounting guide 18b is substantially at the same height as the guide surface 41a2 of the movable guide 41.

The movable guide 41 in the process cartridge mounting and dismounting mechanism according to the present embodiment is designed to be moved in operative association with the opening and closing operation of the opening and closing cover 15. Therefore, if the movable guide 41 is of a construction in which the rear end thereof (the opening and closing cover side end surface) can be pushed by the process cartridge B, the movable guide 41 will escape into the interior of the image forming apparatus and it will become impossible to bring the mounting guide 18b of the process cartridge B into the guide groove 41a of the movable guide 41. Therefore, in the present embodiment, upstream of the movable guide 41 with respect to the direction of mounting of the process cartridge B (the direction indicated by the arrow X), there is provided an auxiliary guide 42 having a mounting and dismounting auxiliary portion 42a fixed to the inner side plate 40 and connecting to the rear end of the movable guide 41. The above-noted problem is solved by this auxiliary guide 42, and the guide rib (mounting guide) 18b of the process cartridge B is reliably guided into the guide groove 41a of the movable guide 41.

Also, because of a construction in which the process cartridge B is mounted on the movable guide 41 moved in operative association with the opening and closing operation of the opening and closing cover 15, in a state in which the opening and closing cover 15 is closed halfway, the movable guide 41 is moved into the image forming apparatus and therefore, a gap is formed between it and the mounting and dismounting auxiliary portion 42a of the auxiliary guide 42. If the amount of closure of the opening and closing cover 15 is small and the gap is of such a degree as can be stridden by the mounting guide 18b, it is possible to effect the mounting of the process cartridge. However, when this gap becomes wider to a certain degree, it becomes impossible to bring the mounting guide 18b of the process cartridge B into the guide groove 41a of the movable guide 41, and when the gap is still wider, it is supposed that the mounting guide 18b comes into this gap and gets into the image forming apparatus. Therefore, in the present embodiment, the insertion of the process cartridge with the opening and closing cover 15 closed halfway is prevented by the convex portions 16a of the back lid 16.

When the amount of closure of the opening and closing cover 15 is great, the convex portions 16a of the back lid 16 become close to the upper regulating portion 42b and the space for permitting the process cartridge to be mounted therein becomes null and thus, the process cartridge cannot be inserted. When the opening and closing cover 15 is closed halfway and the process cartridge is still insertable, the convex portions 16a enter in the original direction of mounting and dismounting (the direction indicated by the arrow X) by the rotation of the opening and closing cover 15, and the rough guide surfaces 16a1 of the back lid 16 becomes steeper in angle than usual and therefore, the process cartridge B becomes insertable only at an angle steeper than usual. When with this opening and closing cover 15 closed halfway, the process cartridge B is inserted at a steep angle in such a manner that the underside of the process cartridge B is along the rough guide surfaces 16a1 of the convex portions 16a, the tip end surface 18b2 of the mounting guide 18b comes into contact with the rear end surface of the movable guide 41 because the guide surface 41a2 of the movable guide 41 and the introduction guide surface 42a2 of the auxiliary cover 42 are discontinuous to each other. At this time, the positioning portion 18a comes into contact with the inclined surface 43b1 of the side guide 43b and the underside of the toner developing frame 10f comes into contact with the convex portions 16a of the back lid 16, and the posture of the process cartridge B is restricted. As the opening and closing cover 15 is further closed from this state in which three portions, namely, the tip end of the mounting guide 18b, the positioning portion 18a and the underside of the toner developing frame 10f abut against the rear end of the movable guide 41, the inclined surface 43b1 of the side guide 43b and the convex portions 16a, respectively, the movable guide 41 is moved into the interior of the image forming apparatus and the convex portions 16a of the back lid 16 are upwardly rotated and therefore, the process cartridge B is counter-clockwisely rotated and at the rear end of the upper surface of the mounting guide 18b, the corner thereof with the orthogonal surface 18b5 abuts against the upper introduction guide surface 42b2 of the auxiliary guide 42, and the opening and closing cover 15 becomes incapable of being closed any further. That is, even if the process cartridge is inserted from the state in which the opening and closing cover 15 is closed halfway, the opening and closing cover 15 cannot be closed and therefore, the problem of the bad mounting of the process cartridge can be obviated.

Here, even when the process cartridge B is inserted from the above-described state in which the opening and closing cover 15 is closed halfway, and the process cartridge B becomes immovable, if the opening and closing cover 15 is rotated again in its opening direction, the movable guide 41 is moved toward the opening W side and pushes the tip end portion 18b2 of the mounting guide 18b and pulls out the process cartridge B. When the gap between the receiving surface 41a1 of the movable guide 41 and the front guide surface 42a1 of the auxiliary guide 42 becomes small and the mounting guide 18b strides the gap, the mounting guide 18b is within the guide groove 41a and the mounting of the process cartridge becomes possible.

While in the aforedescribed embodiment, the seal construction between the developing blade 10e and the toner developing frame 10f1 has been shown by way of example and described, the present invention is not restricted thereto, but even in the seal construction between the cleaning blade and the cleaning frame, the leakage of the toner can likewise be prevented if a double-sided adhesive tape is likewise stuck on the rubber portion and a portion of the cleaning frame is set so as to eat thereinto.

Also, while the process cartridge shown in the aforedescribed embodiment has been shown by way of example with respect to a case where a monochromatic image is formed, the process cartridge according to the present invention can also be suitably applied to a cartridge provided with a plurality of developing means for forming plural colors of images (for example, a two-color image, a three-color image or a full-color image).

Also, the electrophotographic photosensitive member is not restricted to the photosensitive drum, but includes the following, for instance. First, a photoconductor is used as the photosensitive member, and photoconductors include, for example, amorphous silicon, amorphous selenium, zinc oxide, titanium oxide and an organic photoconductor (OPC) or the like. Also, as a shape for carrying the photosensitive member thereon, use is made, for example, of a drum shape or a belt shape, and for example, in a drum type photosensitive member, a photoconductor is deposited by evaporation or applied by coating onto a cylinder of an aluminum alloy.

Also, as the developing method, use can be made of one of various developing methods such as the conventional two-component magnetic brush development, the cascade development, the touchdown development and the cloud development.

Also, while in the aforedescribed embodiment, the so-called contact charging method is used as the construction of the charging means, use may be course be made of a construction in which a metal shield of aluminum or the like is provided on the three surrounding sides of a heretofore used tungsten wire and positive or negative ions created by a high voltage being applied to the tungsten wire are moved to the surface of a photosensitive drum to thereby uniformly charge the surface of the drum.

The charging means is not restricted to the roller type, but may also be of the blade (charging blade) type, the pad type, the block type, the rod type or the wire type.

Also, as the cleaning means for removing the toner residual on the photosensitive drum, a blade, a fur brush, a magnetic brush or the like may be used to construct the cleaning means.

Also, the aforedescribed process cartridge is provided, for example, with an electrophotographic photo-sensitive member and at least one of process means. Accordingly, the forms of the process cartridge include, besides the aforedescribed embodiment, for example, one in which an electrophotographic photosensitive member and developing means are integrally made into a cartridge detachably mountable on the main body of the apparatus, and one in which an electrophotographic photosensitive member, developing means and one of charging means and cleaning means are combined together and integrally made into a cartridge detachably mountable on the main body of the apparatus.

That is, the aforedescribed process cartridge refers to at least developing means and an electrophotographic photosensitive member integrally made into a cartridge detachably mountable on the main body of the image forming apparatus. This process cartridge can be mounted and dismounted on and from the main body of the apparatus by the user himself. Accordingly, the maintenance of the main body of the apparatus can be effected by the user himself.

Further, while in the aforedescribed embodiment, a laser beam printer has been shown by way of example as the electrophotographic image forming apparatus, the present invention need not be restricted thereto, but of course can also be used, for example, in an electrophotographic printer such as an electrophotographic copying machine or an LED printer, a facsimile apparatus or a word processor, or an electrophotographic image forming apparatus such as a compound machine of these (a multifunction printer or the like).

As described above, according to the present invention, it is possible to effect the reinforcement of the frame and improve the toner leakage preventing performance by a simple construction, and realize an inexpensive toner leakage preventing construction.

The present invention is not restricted to the above-described embodiment, but covers modifications within the technical idea thereof.

What is claimed is:

1. A cartridge detachably mountable on an image forming apparatus, comprising:
a frame; an
a blade member held by said frame;
wherein a double-sided adhesive tape is stuck between said frame and said blade member along a lengthwise direction of said blade member.

2. A cartridge according to claim 1, wherein said blade member has an elastic blade and a metal plate for holding said elastic blade, and said blade member is fixed to said frame at lengthwisely opposite end portions of said metal plate by screws.

3. A cartridge according to claim 2, wherein said double-sided adhesive tape is stuck between the screws at the lengthwisely opposite end portions.

4. A cartridge according to claim 2, wherein said double-sided adhesive tape is stuck between said elastic blade and said frame.

5. A cartridge according to claim 4, wherein said double-sided adhesive tape has a function of sealing a space between said frame and said elastic blade.

6. A cartridge according to claim 1, wherein said frame eats into said blade member through said double-sided adhesive tape.

7. A cartridge according to claim 1, further comprising a containing portion for containing a developer, and a developer bearing member bearing the developer thereon, and wherein said blade member has a function of regulating a layer thickness of the developer borne on said developer bearing member.

8. A cartridge according to claim 7, wherein said frame has a first part provided with a grip, and a second part coupled to said first part, and said developer bearing member and said blade member are held by said first part.

9. A cartridge according to claim 8, further comprising an image bearing member held by said second part.

10. A cartridge according to claim 1, further comprising an image bearing member, and wherein said blade member has a function of clearing said image bearing member with said blade member in contact with said image bearing member.
